(19) United States
(12) Patent Application Publication
(10) Pub. No.: US 2011/0055446 A1
(43) Pub. Date: Mar. 3, 2011

(54) SEMICONDUCTOR INTEGRATED CIRCUIT DEVICE

(75) Inventor: Makoto Fujii, Tokyo (JP)

(73) Assignee: RENESAS ELECTRONICS CORPORATION

(21) Appl. No.: 12/874,426

(22) Filed: Sep. 2, 2010

(30) Foreign Application Priority Data
Sep. 2, 2009 (JP) JP2009-202183
Mar. 5, 2010 (JP) JP2010-048918

(51) Int. Cl. G06F 13/26

(52) U.S. Cl. 710/264

(57) ABSTRACT

When an interrupt event occurs, an interrupt request signal and interrupt data are output from an arbitrary peripheral module to an interrupt control circuit. The interrupt control circuit stores the received interrupt data in a register and performs a priority determination of the interrupt request signal. Subsequently, the interrupt control circuit transfers the determination result as an interrupt request signal via a dedicated wiring and the interrupt data of the register via a dedicated bus to the CPU, respectively. Upon reception of the interrupt request, the CPU reads a corresponding interrupt processing function from a ROM and performs the processing of the interrupt data based on the input interrupt request signal.

### CROSS-REFERENCE TO RELATED APPLICATION

The present application claims priority from Japanese Patent Application No. 2009-202183 filed on Sep. 2, 2009 and Japanese Patent Application No. 2010-048918 filed on Mar. 5, 2010, the contents of which are hereby incorporated by reference to this application.

### TECHNICAL FIELD OF THE INVENTION

The present invention relates to an interrupt processing technique in a semiconductor integrated circuit device, and more particularly to a technique effective in reducing a load factor of a central processing unit (CPU) in the interrupt processing.

### BACKGROUND OF THE INVENTION

With respect to an in-vehicle semiconductor integrated circuit device, for example, it has been widely known that communication between electrical control units (ECU) in each of which the semiconductor integrated circuit device is mounted is performed by using an in-vehicle serial protocol such as a controller area network (CAN).

In that case, particularly in a body control system, interrupts caused by transmission completion, reception completion and error occurrence are generated to perform processings such as next transmission, read of received data and determination of an error factor.

Also in the case of controlling a motor by the ECU in which the semiconductor integrated circuit device is mounted, timer interrupts are generated at regular time intervals to perform processings such as adjustment of the motor rotation speed.

As this type of interrupt processing technique in a semiconductor integrated circuit device, Japanese Patent Application Laid-Open Publication No. 2007-272554 (Patent Document 1) discloses a technique, which comprises: a CPU; a first bus connected to the CPU; a second bus having a data transfer rate lower than that of the first bus; an interrupt processing circuit connected to the first bus; and a peripheral module connected to the second bus and accessible from the CPU, wherein the CPU performs the processing of accessing the interrupt processing circuit without accessing the peripheral module when analyzing the interrupt factor, thereby improving the stall cycle of the CPU.

### SUMMARY OF THE INVENTION

However, the inventor of the present invention has found that the interrupt processing technique in the semiconductor integrated circuit device described above has following problems.

In the interrupt processing, when an interrupt is generated from a peripheral module and an interrupt request is notified to the CPU, the CPU reads an interrupt processing function and reads interrupt data such as status from the peripheral module, thereby performing the interrupt processing.

When the system is complicated and the communication volume is increased, the frequency of the interrupt is accordingly increased, and not only the overhead of the interrupt generation but also the access to the peripheral module inevitably generated in the interrupt is increased.

Since the CPU reads interrupt data from the interrupt processing circuit or the peripheral module via a low-speed bus, when the interrupt processing is increased, the load on the CPU is increased and the processing ability is impaired, and furthermore, the multiple interrupts are redundantly generated before the processing of the CPU is performed and the previously-generated interrupt processing itself cannot be performed.

An object of the present invention is to provide a technique capable of reducing a load factor of a CPU by reducing the frequency of the access to a peripheral module in an interrupt processing.

The above and other objects and novel characteristics of the present invention will be apparent from the description of the present specification and the accompanying drawings.

The following is a brief description of an outline of the typical invention disclosed in the present application.

A semiconductor integrated circuit device of the present invention comprises: a CPU; an interrupt control circuit for controlling an interrupt processing to the CPU; a first bus to which the CPU and the interrupt control circuit are connected; at least one peripheral module which is accessible from the CPU; and a second bus to which the peripheral module is connected and which has a data transfer rate lower than that of the first bus, wherein, when an interrupt from the peripheral module is generated, the interrupt control circuit reads interrupt data from the peripheral module, outputs an interrupt request signal to the CPU to notify the interrupt generation and also performs a processing to transfer the interrupt data read from the peripheral module to the CPU.

Also, in the semiconductor integrated circuit device of the present invention, the interrupt control circuit includes: a storage unit which stores the interrupt data output from the peripheral module when the interrupt request signal is output from the peripheral module; and a priority determination unit which determines an interrupt priority based on the interrupt request signal output from the peripheral module from which the interrupt is generated and outputs its determination result and the interrupt data stored in the storage unit to the CPU.

Further, in the semiconductor integrated circuit device of the present invention, the priority determination unit and the CPU are connected by a dedicated bus, and the interrupt data of the peripheral module is transferred via the dedicated bus.

Furthermore, in the semiconductor integrated circuit device of the present invention, the peripheral module and the interrupt control circuit are connected by a serial bus, and the interrupt data is transferred from the peripheral module by serial communication.

Furthermore, an outline of another invention of the present application will be briefly described below.

A semiconductor integrated circuit device of the present invention comprises: two or more CPUs; an interrupt control circuit for controlling an interrupt processing to the two or more CPUs; a first bus to which the two or mores CPUs and the interrupt control circuit are connected; at least one peripheral module which is accessible from the two or more CPUs; and a second bus to which the peripheral module is connected and which has a data transfer rate lower than that of the first bus, wherein, when an interrupt from the peripheral module is generated, the interrupt control circuit reads interrupt data from the peripheral module, outputs an interrupt request signal to one of the CPUs to notify the interrupt generation and also performs a processing to transfer the interrupt data of the peripheral module to the one of the CPUs.

Also, in the semiconductor integrated circuit device of the present invention, the interrupt control circuit includes: a storage unit which stores the interrupt data output from the peripheral module when the interrupt request signal is output from the peripheral module; a priority determination unit which determines an interrupt priority based on the interrupt request signal output from the peripheral module from which the interrupt is generated; and an interrupt notification determination unit which determines which CPU of the two or more CPUs the interrupt is notified to and outputs a determination result of the priority determination unit and the interrupt data stored in the storage unit to the determined CPU.

Further, in the semiconductor integrated circuit device of the present invention, the interrupt notification determination unit and the CPU are connected by a dedicated bus, and the interrupt data of the peripheral module is transferred via the dedicated bus.

Furthermore, in the semiconductor integrated circuit device of the present invention, the peripheral module and the interrupt control circuit are connected by a serial bus, and the interrupt data is transferred from the peripheral module by serial communication.

The effects obtained by the typical inventions disclosed in the present application will be briefly described below.

(1) The CPU load factor in the interrupt processing can be significantly reduced.

(2) According to (1) above, the clock speed required for the CPU can be lowered, and therefore, the power consumption of the semiconductor integrated circuit device can be reduced.

(3) According to (1) above, even when the interrupt processing is increased, the interrupt processing error can be prevented, and therefore, the reliability of the semiconductor integrated circuit device can be improved.

### BRIEF DESCRIPTIONS OF THE DRAWINGS

FIG. 1 is a block diagram showing an example of a semiconductor integrated circuit device according to the first embodiment of the present invention;

FIG. 2 is a block diagram showing an example of a general semiconductor integrated circuit device studied by the inventor of the present invention;

FIG. 3 is a block diagram showing an example of the semiconductor integrated circuit device shown in the Patent Document 1;

FIG. 4 is an explanatory diagram showing an example of the interrupt processing of the motors;

FIG. 5 is a diagram showing an example of interrupt function programs used in the semiconductor integrated circuit devices shown in FIG. 1 and FIG. 2;

FIG. 6 is a block diagram showing an example of a semiconductor integrated circuit device according to the second embodiment of the present invention;

FIG. 7 is a timing chart showing an example of an interrupt processing in the semiconductor integrated circuit device of FIG. 6;

FIG. 8 is a timing chart showing a comparison with an example of the interrupt processing in the case where the semiconductor integrated circuit device of FIG. 2 studied by the inventor of the present invention has a dual-core configuration;

FIG. 9 is a timing chart showing a comparison with an example of the interrupt processing in the case where the semiconductor integrated circuit device of FIG. 3 studied by the inventor of the present invention has a dual-core configuration;

FIG. 10 is a block diagram showing another example of the semiconductor integrated circuit device of FIG. 1 studied by the inventor of the present invention;

FIG. 11 is a timing chart showing an example of an interrupt processing of the semiconductor integrated circuit device of FIG. 10 studied by the inventor of the present invention;

FIG. 12 is a block diagram showing another example of the semiconductor integrated circuit device of FIG. 1 studied by the inventor of the present invention; and

FIG. 13 is a timing chart showing another example of an interrupt processing of the semiconductor integrated circuit device of FIG. 12 studied by the inventor of the present invention.

### DESCRIPTIONS OF THE PREFERRED EMBODIMENTS

Hereinafter, embodiments of the present invention will be described in detail with reference to the accompanying drawings. Note that components having the same function are denoted by the same reference symbols throughout the drawings for describing the embodiments, and the repetitive description thereof will be omitted.

### First Embodiment

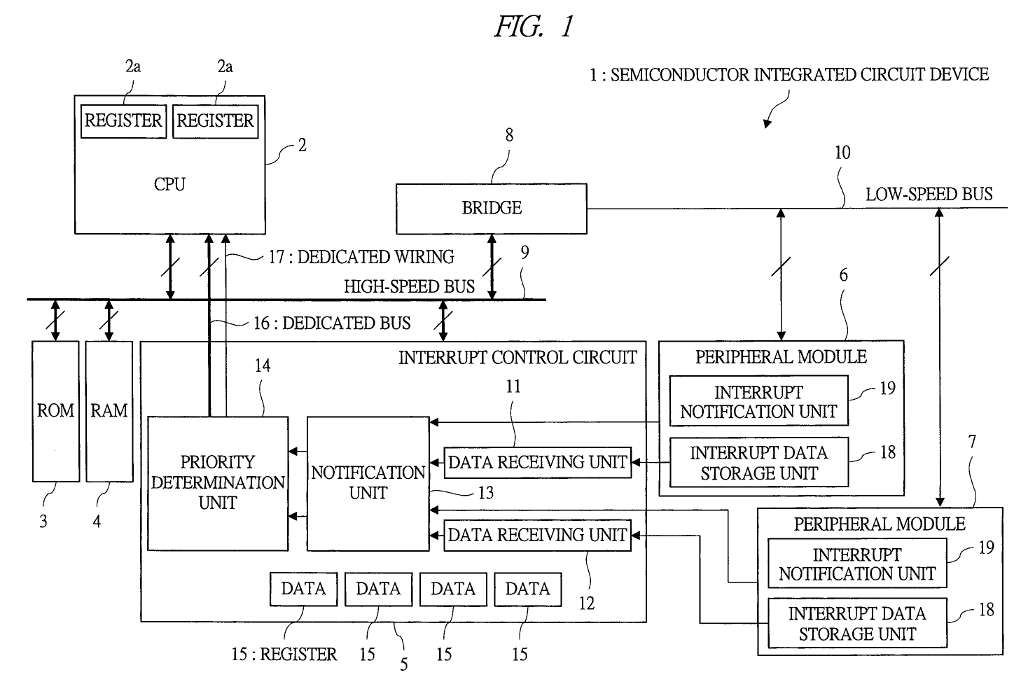

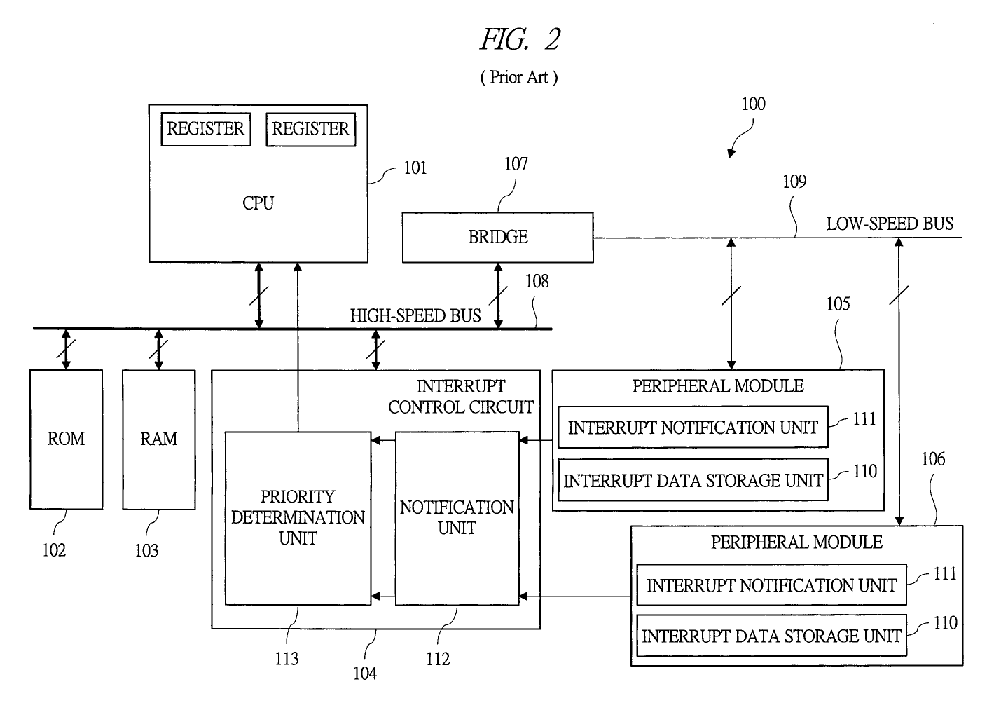

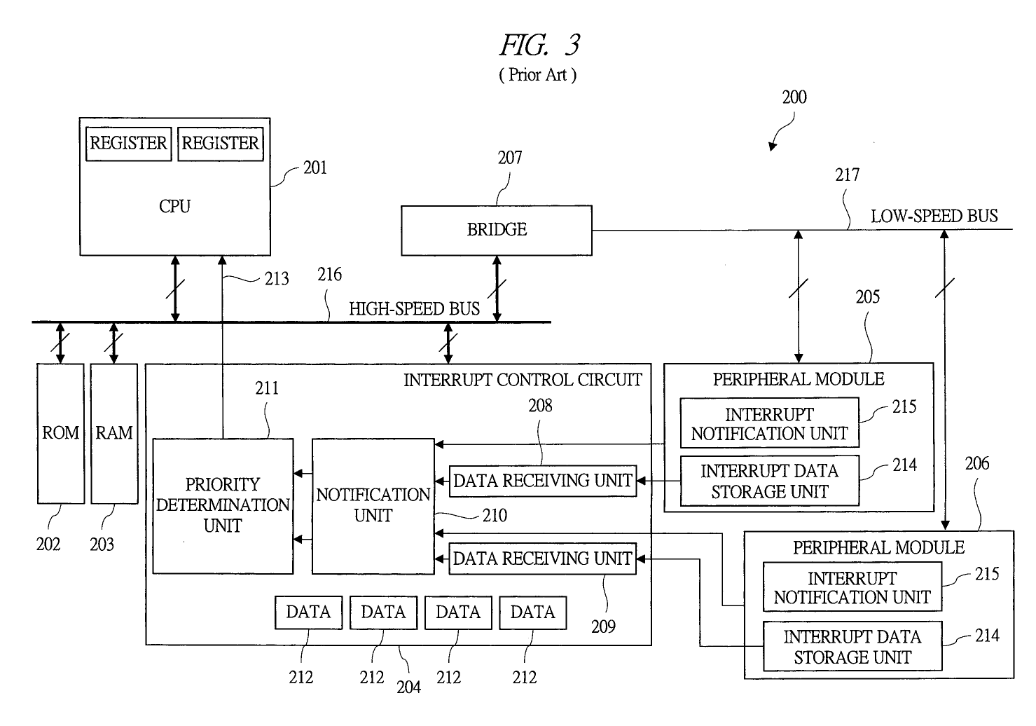

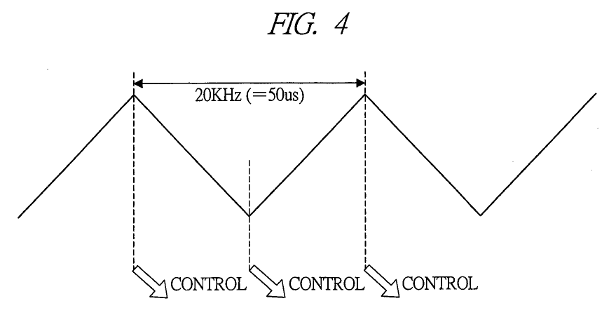

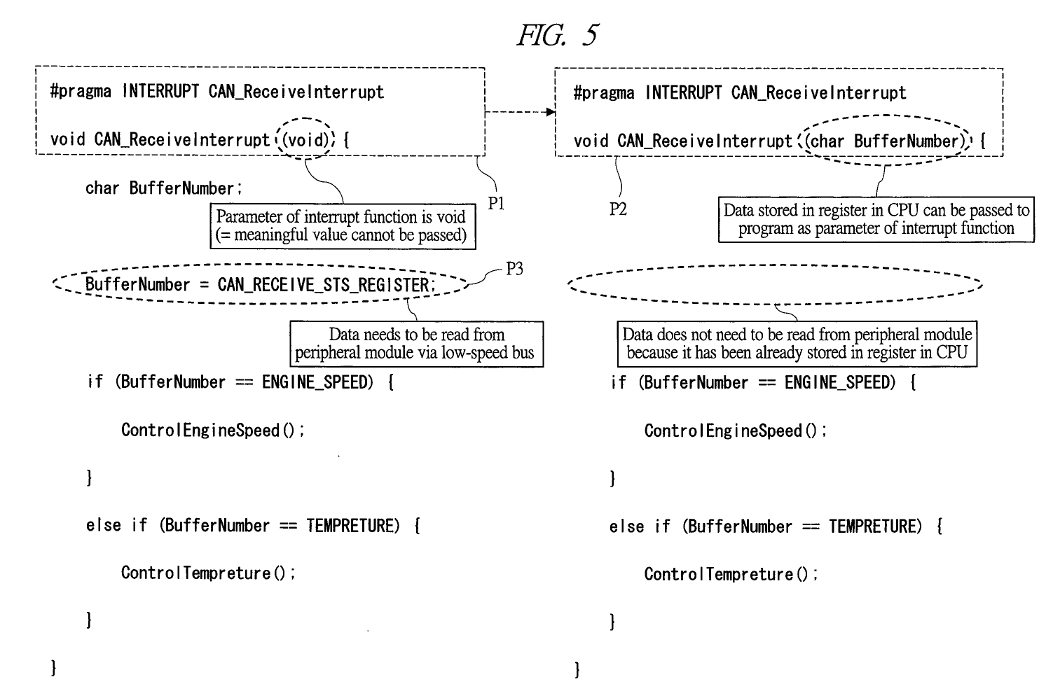

FIG. 1 is a block diagram showing an example of a semiconductor integrated circuit device according to the first embodiment of the present invention, FIG. 2 is a block diagram showing an example of a general semiconductor integrated circuit device studied by the inventor of the present invention, FIG. 3 is a block diagram showing an example of a semiconductor integrated circuit device described in the Patent Document 1, FIG. 4 is an explanatory diagram showing an example of an interrupt processing of motors, and FIG. 5 is a diagram showing an example of interrupt function programs used in the semiconductor integrated circuit devices shown in FIG. 1 and FIG. 2.

In the first embodiment, the semiconductor integrated circuit device 1 is mounted in, for example, an in-vehicle ECU (Electric Control Unit). The ECU performs the control of various types of systems such as the information system including a navigation system and an audio system, the power train system including a motor, an engine and a chassis and the body control system including an air conditioner, a head light and a door lock.

As shown in FIG. 1, the semiconductor integrated circuit device 1 is made up of a CPU 2, a read only memory (ROM) 3, a random access memory (RAM) 4, an interrupt control circuit 5, peripheral modules 6 and 7, a bridge 8 and others. The CPU 2 performs all controls in the semiconductor integrated circuit device 1.

The ROM 3 is a read-only nonvolatile memory and stores, for example, a program and others for operating the CPU 2. The RAM 4 is a volatile memory or the like and is used as a work space of arithmetic processing in the CPU 2.

The interrupt control circuit 5 controls the interrupt processing to the CPU 2. The peripheral modules 6 and 7 are modules having a timer function, a communication function and others.

The CPU 2, the ROM 3, the RAM 4, the interrupt control circuit 5 and the bridge 8 are mutually connected via a high-speed bus 9 serving as a first bus, and the peripheral modules 6 and 7 and the bridge 8 are mutually connected via a low-speed bus 10 serving as a second bus.

The bridge 8 connects the high-speed bus 9 and the low-speed bus 10. The high-speed bus 9 is a bus capable of high-speed communication, and the low-speed bus 10 is a bus through which lower-speed communication compared with the high-speed bus 9 is performed.

Also, the interrupt control circuit 5 is provided with data receiving units 11 and 12, a notification unit 13, a priority determination unit 14 and a plurality of registers 15. The data receiving unit 11 receives interrupt data (or interrupt factor) relating to the interrupt output from the peripheral module 6, and the data receiving unit 12 receives interrupt data relating to the interrupt output from the peripheral module 7. The notification unit 13 receives an interrupt notification signal output from the peripheral modules 6 and 7.

The data receiving unit 11 and the peripheral module 6, and the data receiving unit 12 and the peripheral module 7 are respectively connected via, for example, a serial bus separately from the low-speed bus 10. The data receiving unit 11 (12) latches the interrupt data transferred from the serial bus in synchronization with a transfer clock output from the peripheral module 6 (7).

The priority determination unit 14 determines a priority of an interrupt notification signal input via the notification unit 13 and outputs the interrupt notification signal to the CPU 2 in order of priority of the interrupt. The register 15 to be a storage unit temporarily stores the interrupt data output from the peripheral modules 6 and 7. Note that, although the example in which the interrupt data is temporarily stored in the register 15 has been described here, the interrupt data may be stored in a memory other than the register.

The priority determination unit 14 and the CPU 2 are connected by a dedicated bus 16 and a dedicated wiring 17. The dedicated bus 16 is a bus through which interrupt information such as status stored in the register 15 is output to the CPU 2, and it may be either of a serial bus or a parallel bus. Also, the dedicated wiring 17 is a wiring through which an interrupt request signal to the CPU 2 is output.

The peripheral modules 6 and 7 are each provided with an interrupt data storage unit 18 and an interrupt notification unit 19. The interrupt data storage unit 18 stores interrupt data at the time of event occurrence. The interrupt notification unit 19 notifies an interrupt notification signal to the interrupt control circuit 5 at the time of event occurrence.

Next, the interrupt processing in the semiconductor integrated circuit device 1 according to the first embodiment will be described. For example, the case where an event occurs in the peripheral module 6 will be described here.

First, when an event by which an interrupt is to be generated occurs, an interrupt request signal is output from the interrupt notification unit 19 of the peripheral module 6, and an interrupt request is notified to the interrupt control circuit 5.

At this time, from the peripheral module 6, the interrupt data stored in the interrupt data storage unit 18 is output. The interrupt data output from the peripheral module 6 is received by the data receiving unit 11 and then stored in the arbitrary register 15.

Subsequently, the interrupt control circuit 5 performs the priority determination so as to determine which interrupt out of the received interrupt request signals is to be generated. Then, the interrupt control circuit 5 notifies the result of the priority determination to the CPU 2 as the interrupt request signal via the dedicated wiring 17 and transfers the interrupt data stored in the register 15 to the CPU 2 via the dedicated bus 16. The CPU 2 stores the input interrupt data in a register 2a provided in the CPU 2. Then, upon reception of the interrupt request, the CPU 2 reads address information at which the corresponding interrupt processing function is disposed from the ROM 3 based on the input interrupt request signal, reads the interrupt processing function from the read address, and executes the processing of the interrupt data stored in the register 2a.

Next, the general interrupt processing studied by the inventor of the present invention will be described with reference to FIG. 2. For example, the case where an event occurs in the peripheral module 105 will be described here.

As shown in FIG. 2, a semiconductor integrated circuit device 100 is made up of a CPU 101, a ROM 102, a RAM 103, an interrupt control circuit 104, peripheral modules 105 and 106, a bridge 107 and others.

Also, the CPU 101, the ROM 102, the RAM 103, the interrupt control circuit 104 and the bridge 107 are mutually connected via a high-speed bus 108, and the peripheral modules 105 and 106 and the bridge 107 are mutually connected via a low-speed bus 109.

Furthermore, the peripheral modules 105 and 106 are each provided with an interrupt data storage unit 110 and an interrupt notification unit 111. These configurations are similar to those of FIG. 1, and the difference exists in the configuration of the interrupt control circuit 104.

The interrupt control circuit 104 is provided with a data receiving unit 112 and a priority determination unit 113, but is not provided with the data receiving unit 11 and the plurality of registers 15 shown in FIG. 1. Further, the priority determination unit 113 and the CPU 101 are connected by the dedicated wiring 17, but the dedicated bus 16 of FIG. 1 is not provided. This is another difference.

Therefore, the interrupt data is read through the low-speed bus 109, the bridge 107 and the high-speed bus 108.

In the interrupt processing, first, when an event by which an interrupt is to be generated occurs in a peripheral module 105, the peripheral module 105 notifies an interrupt request signal to the interrupt control circuit 104.

The priority determination unit 113 of the interrupt control circuit 104 performs the priority determination so as to determine which interrupt out of the received interrupt request signals is to be generated and then notifies the result of the priority determination to the CPU 101 as the interrupt request signal.

Then, upon reception of the interrupt request signal, the CPU 101 reads the corresponding interrupt processing function from the ROM 102 and executes the processing. At this time, the CPU 101 reads interrupt data such as status from the interrupt data storage unit 110 in the peripheral module 105 via the high-speed bus 108, the bridge 107 and the low-speed bus 109 and executes the interrupt processing.

As described above, in the configuration of the semiconductor integrated circuit device 100 of FIG. 2, when the interrupt processing is generated, after the interrupt priority determination is performed, the processing of reading the interrupt data from the corresponding peripheral module via the low-speed bus 109 is necessary.

On the other hand, in the semiconductor integrated circuit device with the configuration of FIG. 1 according to the first embodiment, since the interrupt data is transferred via the dedicated bus 16 through the interrupt control circuit 5 in advance together with the result of the interrupt priority determination when the interrupt is generated, the processing load of the CPU 2 can be significantly reduced.

Next, the interrupt processing in the semiconductor integrated circuit device disclosed in the above-mentioned Patent Document 1 (Japanese Patent Application Laid-Open Publication No. 2007-272554) will be described.

In this case, a semiconductor integrated circuit device 200 is made up of a CPU 201, a ROM 202, a RAM 203, an interrupt control circuit 204, peripheral modules 205 and 206, a bridge 207 and others as shown in FIG. 3, and it has the same configuration as that shown in FIG. 1.

Furthermore, similar to FIG. 1, the interrupt control circuit 204 is provided with data receiving units 208 and 209, a notification unit 210, a priority determination unit 211 and a plurality of registers 212. The priority determination unit 211 and the CPU 201 are connected by a dedicated wiring 213, and the difference from FIG. 1 is that the dedicated bus 16 (FIG. 1) is not provided. Also, similar to FIG. 1, the peripheral modules 205 and 206 are each provided with an interrupt data storage unit 214 and an interrupt notification unit 215.

Also, the CPU 201, the ROM 202, the RAM 203, the interrupt control circuit 204 and the bridge 207 are mutually connected via a high-speed bus 216, and the peripheral modules 205 and 206 and the bridge 207 are mutually connected via a low-speed bus 217.

In the interrupt processing, first, when an event by which an interrupt is to be generated occurs in a peripheral module 205, for example, the interrupt notification unit 215 of the peripheral module 205 notifies an interrupt request signal to the interrupt control circuit 204. Furthermore, the peripheral module 205 transfers interrupt data such as status stored in the interrupt data storage unit 214 to the interrupt control circuit 204. The interrupt control circuit 204 stores the transferred interrupt data in the arbitrary register 212.

Then, the interrupt control circuit 204 performs the priority determination so as to determine which interrupt out of the received interrupt requests is to be generated and then notifies the high-priority interrupt request to the CPU 201 as the interrupt request signal.

Upon reception of receiving the interrupt request signal, the CPU 201 reads the corresponding interrupt processing function from the ROM 202, reads interrupt data from the register 212 of the interrupt control circuit 204 via the high-speed bus 216, and executes the interrupt processing.

As described above, since the interrupt data is read from the interrupt control circuit 204 when reading the interrupt processing function, the processing load of the CPU 201 can be reduced compared with the semiconductor integrated circuit device 100 of FIG. 2, but the processing load is increased compared with the semiconductor integrated circuit device of FIG. 1.

The CPU processing by the general interrupt processing in FIG. 1 to FIG. 3 will be studied here.

Here, the case where four motors are controlled in 20 KHz as shown in FIG. 4 will be described as an example of the general interrupt processing. At that time, the CPU is set to make two controls with one rotation of the motor. Further, 8 cycles are required for the access to the peripheral module from the low-speed bus, and 4 cycles are required for the access to the high-speed bus from the interrupt control circuit.

Also, the processing of the CPU in one interrupt processing requires a total of about 350 cycles including: (1) interrupt response (ten and several cycles); (2) interrupt data acquisition from the peripheral module (28 bus access cycles); (3) arithmetic operation of correction value by the CPU (several tens of cycles); (4) timer value output (8 bus access cycles); and (5) return from interrupt (several cycles).

In the interrupt processing under the above-described conditions, since the CPU 101 makes two controls in 20 KHz (50 μs) in the case of the semiconductor integrated circuit device 100 of FIG. 2, the one control has to be performed in 50 μs/2=25 μs.

Since the one processing is about 350 cycles as described above, 1400 cycles are required for controlling the four motors (350×4=1400). Thus, the one cycle time is 25 μs/1400=0.0179 μs=17.9 ns, and the required clock speed (operation frequency) is 1/17.9 ns=55.9 MHz.

When the CPU load to be used for the motor control is, for example, about 10%, the clock speed has to be increased to 55.9 MHz/0.1=559 MHz.

Next, in the case of the semiconductor integrated circuit device 200 of FIG. 3, compared with the case of FIG. 2, the 28 accesses to the peripheral module via the low-speed bus in the data acquisition can be replaced by the accesses via the high-speed bus.

As a result, the one processing becomes 238 cycles (350−28×(8−4)=238), and 952 cycles are required for the control of the four motors (238×4=952).

Then, the one cycle time is 25 μs/952=0.0263 μs=26.3 ns, and the required clock speed is 1/26.3 ns=38 MHz. Therefore, in order to suppress the load factor of the CPU 201 to about 10%, the required clock speed is 380 MHz (38 MHz/0.1=380), and can be reduced compared with that of the semiconductor integrated circuit device 100 of FIG. 2.

Next, in the case of the semiconductor integrated circuit device 1 according to the first embodiment, the 28 accesses to the high-speed bus 9 in the interrupt data acquisition can be eliminated from the interrupt processing to be performed by the CPU 2, and thus can be eliminated from the operation of the CPU 2.

Then, the one processing becomes 126 cycles (238−28×4=126). Therefore, 504 cycles are required for the control of the four motors (126×4=504).

As a result, the one cycle time is 25 μs/504=0.0469 μs=49.6 ns, and the required clock speed is 1/49.6 ns=20 MHz. Therefore, in order to suppress the load factor of the CPU to about 10%, the clock speed is 20 MHz/0.1=200 MHz, and can be reduced to about 200 MHz.

Since the power consumption is proportional to the clock frequency of the CPU, the power consumption can be reduced by about 47% in the semiconductor integrated circuit device 1 compared with the semiconductor integrated circuit device 200 of FIG. 3.

Next, the CPU processing in FIG. 1 to FIG. 3 when controlling the motors by using a resolver will be studied.

The resolver detects a rotation angle of a rotator (output shaft) of the motor, and for example, the output of the resolver is converted to a rotation angle and the rotation of the motor is controlled in accordance with the rotation angle.

In this case, the control by the resolver is made with 12-bit accuracy in 500 Hz. Also, the access conditions are the same as those described above, and 8 cycles are required for the access to the peripheral module from the low-speed bus and 4 cycles are required for the access to the high-speed bus from the interrupt control circuit.

Furthermore, the processing of the CPU in one interrupt processing requires a total of about 80 cycles including: (1) interrupt response (ten and several cycles); (2) acquisition of rotation period and resolver value (2 bus access cycles); (3) arithmetic operation of correction value by the CPU (several tens of cycles); (4) addition and subtraction of resolver value counter (several cycles); (5) resolver value output (2 bus access cycles); and (6) return from interrupt (several cycles).

First, in the case of the semiconductor integrated circuit device 100 of FIG. 2, since the CPU 101 makes a control with 12-bit resolution in 500 Hz (2 ms), the one control has to be performed in 2 ms/212=488 ns.

Since the one processing is 80 cycles, the one cycle time is 488/90=6.1 ns, and the required clock speed is 1/6.1 ns=164 MHz. In order to suppress the load factor of the CPU to about 10%, about 1.64 GHz is required (164 MHz/0.1).

Next, in the case of the semiconductor integrated circuit device 200 of FIG. 3, since the access to the peripheral module can be performed by the access to the high-speed bus 216 as described above, when the access via the low-speed bus requires 8×CPU cycle and the access via the high-speed bus requires 4×CPU cycle, the reduction of 8 cycles can be achieved because two accesses to the peripheral module occur.

Accordingly, the one processing becomes 72 cycles (80-2×(8−4)), and the required clock speed is 1/(488 ns/72)=147 MHz. As a result, from 1-(147/164)=0.104, the power consumption by the clock operation of the CPU can be reduced by about 10% compared with the semiconductor integrated circuit device 100 of FIG. 2.

On the other hand, in the semiconductor integrated circuit device 1 of FIG. 1, the access to the peripheral module can be eliminated from the interrupt processing to be performed by the CPU 2, and thus can be eliminated from the clock operation of the CPU 2.

Therefore, the one processing becomes 72˜8=64 cycles, and the required clock speed becomes 1/(488 ns/64)=131 MHz. As a result, from 1−(131/164)=0.20, the power consumption can be reduced by about 20% compared with the semiconductor integrated circuit device 100 of FIG. 2.

Here, by transferring the address information at which the corresponding interrupt processing function is disposed as well as the interrupt data to the CPU 2 together with the interrupt data, the one cycle as the interrupt response processing can be reduced.

In this case, the one processing becomes 64−1=63 cycles, and the required clock speed becomes 1/(488 ns/63)=129 MHz. As a result, from 1−(129/164)=0.21, the power consumption can be reduced by about 21%.

FIG. 5 shows an example of interrupt function programs. The program shown on the left side of FIG. 5 is the interrupt function program used for the semiconductor integrated circuit device 100 of FIG. 2, and the program shown on the right side of FIG. 5 is the interrupt function program applied to the semiconductor integrated circuit device 1 of FIG. 1.

In the program example P1 shown on the left side of FIG. 5, a factor of the interrupt function is “void” (shown by a circle of a dotted line), but in the program example P2 on the right side of FIG. 5, it is “char BufferNumber” and the data stored in the register in the CPU can be transmitted to the program as the factor of the interrupt function.

Also, in the interrupt function program shown on the left side of FIG. 5 and used for the semiconductor integrated circuit device 100, as shown by a program example P3, a program description for reading the interrupt data from the peripheral module via the low-speed bus is required, but in the interrupt function program shown on the right side of FIG. 5 and used for the semiconductor integrated circuit device 1, since the interrupt data is stored in the register in the CPU when the interrupt request signal is input, the program for reading the interrupt data from the peripheral module is unnecessary.

### Second Embodiment

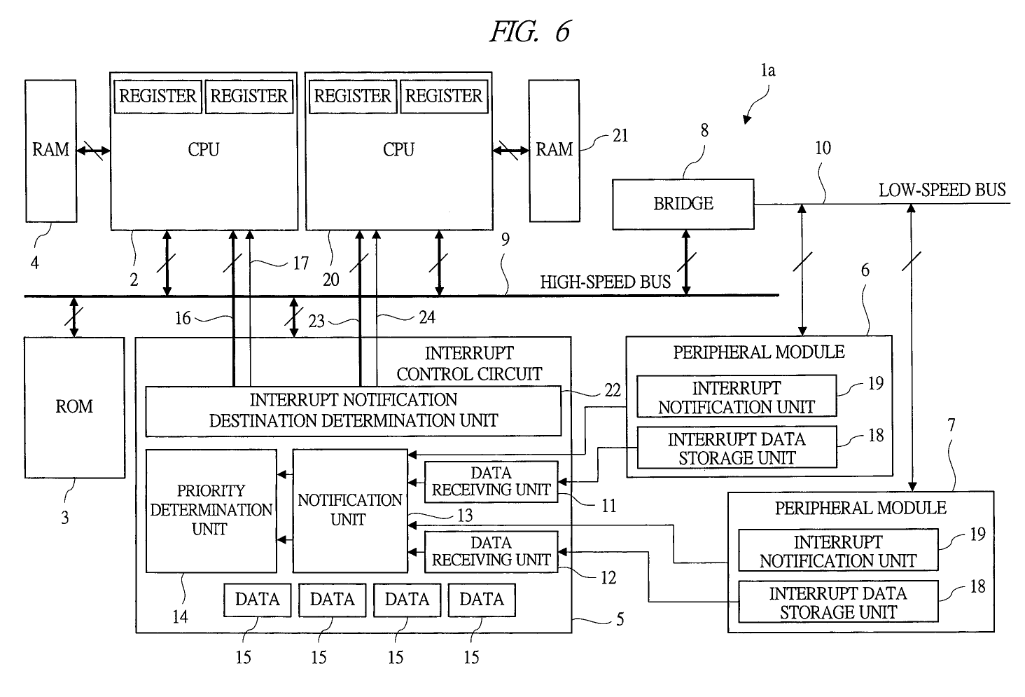

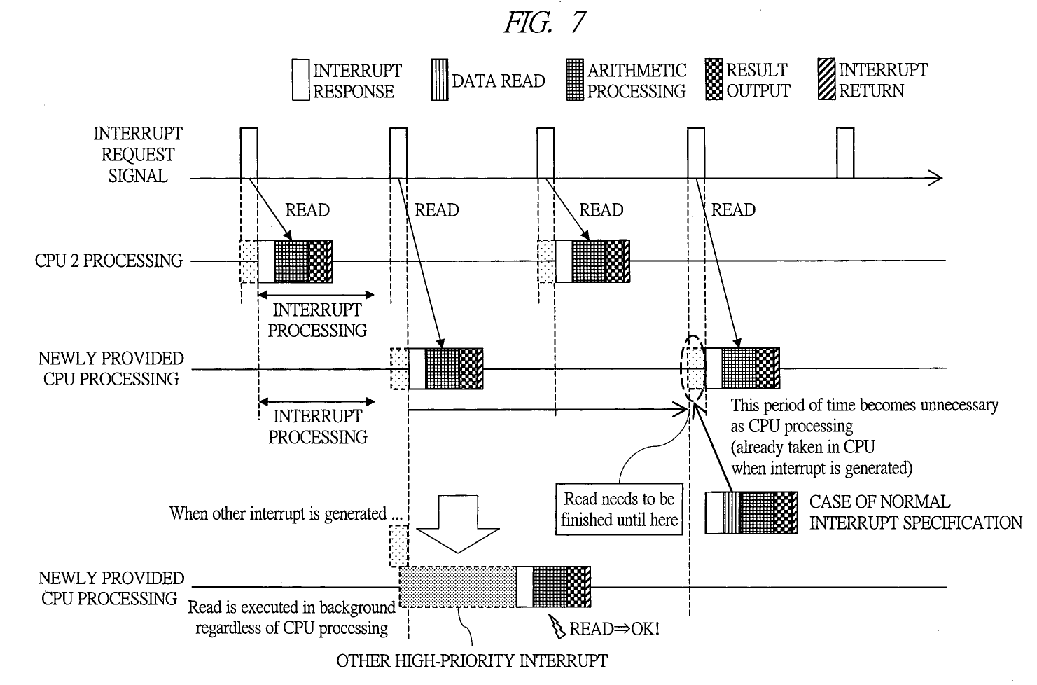

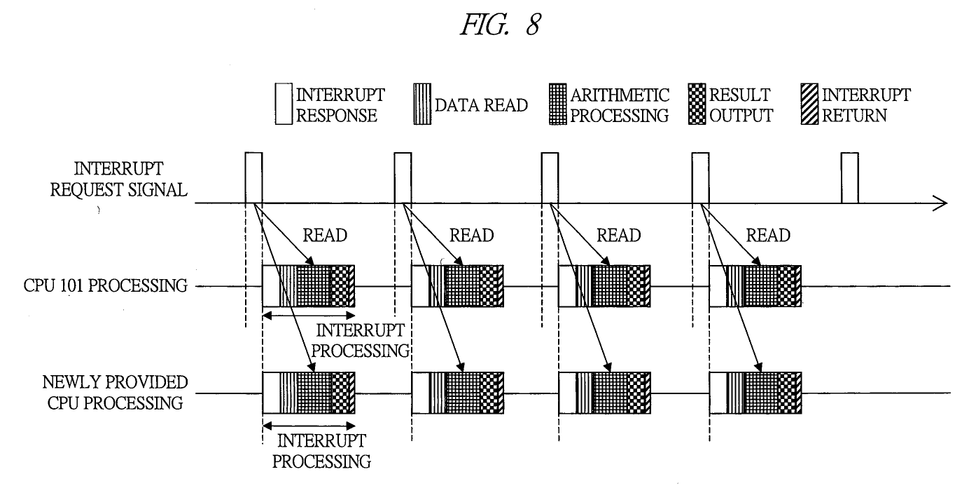

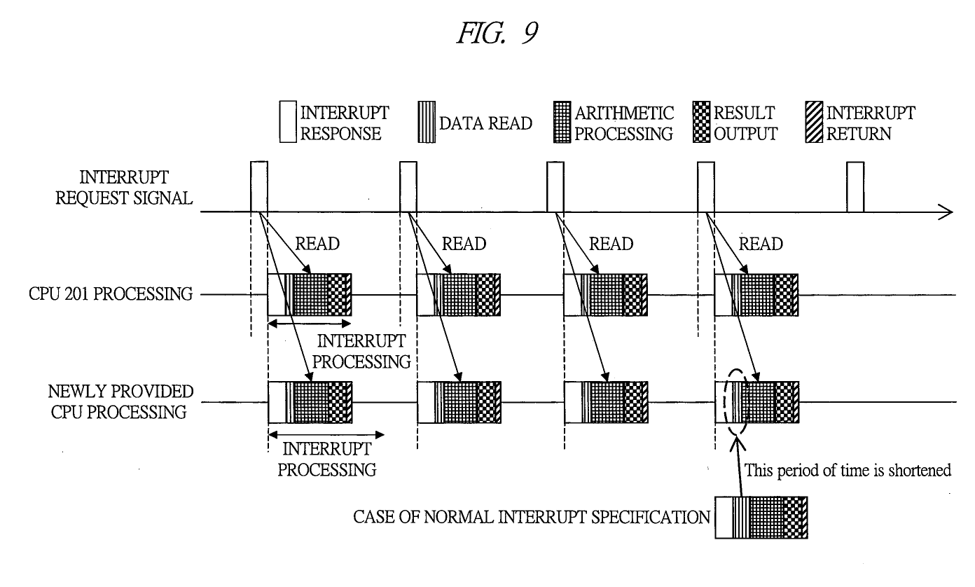

FIG. 6 is a block diagram showing an example of a semiconductor integrated circuit device according to the second embodiment of the present invention, FIG. 7 is a timing chart showing an example of the interrupt processing in the semiconductor integrated circuit device of FIG. 6, FIG. 8 is a timing chart showing an example of the interrupt processing in the case where the semiconductor integrated circuit device of FIG. 2 studied by the inventor of the present invention has a dual-core configuration, and FIG. 9 is a timing chart showing an example of the interrupt processing in the case where the semiconductor integrated circuit device of FIG. 3 studied by the inventor of the present invention has a dual-core configuration.

In the second embodiment, the semiconductor integrated circuit device 1a has a multi-core configuration. This is the difference from the semiconductor integrated circuit device 1 of FIG. 1 in the first embodiment. In the semiconductor integrated circuit device 1a, as shown in FIG. 6, a CPU 20 and a RAM 21 are newly provided for the configuration of FIG. 1 made up of the CPU 2, the ROM 3, the RAM 4, the interrupt control circuit 5, the peripheral modules 6 and 7, the bridge 8 and others. The CPU 20 is connected to the high-speed bus 9, and the CPU 20 and the interrupt control circuit 5 are connected by a dedicated bus 23 and a dedicated wiring 24. Also, an interrupt notification destination determination unit 22 is newly provided in the interrupt control circuit 5. The interrupt notification destination determination unit 22 determines which CPU of the CPU 2 and the CPU an interrupt is notified to. Since other connection configuration is the same as that of the semiconductor integrated circuit device 1 of FIG. 1 in the first embodiment, the description thereof is omitted here.

Note that, although the dual-core configuration in which two CPUs are provided is shown in FIG. 6, the multi-core configuration having three or more CPUs may also be used.

Next, the interrupt processing by the semiconductor integrated circuit device 1a according to the second embodiment will be described. For example, the case where an event occurs in the peripheral module 6 will be described here.

First, when an event by which an interrupt is to be generated occurs, an interrupt request signal is output from the interrupt notification unit 19 of the peripheral module 6, and an interrupt request is notified to the interrupt control circuit 5.

At this time, from the peripheral module 6, the interrupt data stored in the interrupt data storage unit 18 is output. The interrupt data output from the peripheral module 6 is received by the data receiving unit 11 and then stored in the arbitrary register 15.

Subsequently, the interrupt control circuit 5 performs the priority determination so as to determine which interrupt out of the received interrupt request signals is to be generated. Then, the interrupt notification destination determination unit 22 determines which CPU of the CPU 2 and the CPU 20 an interrupt request is notified to, notifies the result of the priority determination to the determined CPU (CPU 2 here) as the interrupt request signal via the dedicated wiring 17, and transfers the interrupt data stored in the register 15 to the CPU 2 via the dedicated bus 16. The CPU 2 stores the input interrupt data in a register 2a provided in the CPU 2.

Then, upon reception of the interrupt request, the CPU 2 reads address information at which the corresponding interrupt processing function is disposed from the ROM 3 based on the input interrupt request signal, reads the interrupt processing function from the read address, and executes the processing of the interrupt data stored in the register 2a.

Here, in the interrupt notification destination determination unit 22, the ratio of the interrupt processing of the CPU 2 and the CPU 20 can be arbitrarily changed by, for example, the user setting. For example, the setting in which the ratio of the interrupt processing is 1:1 and the CPU 2 and the CPU 20 alternately perform the interrupt processing, the setting in which the CPU 2 and the CPU 20 perform the interrupt processing with the ratio of 1:2, the setting in which the CPU 2 and the CPU 20 simultaneously perform the interrupt processing and others can be arbitrarily selected.

FIG. 7 is a timing chart showing an example of the interrupt processing in the semiconductor integrated circuit device 1a of FIG. 6.

From the top to the bottom of FIG. 7, the interrupt request signals input to the CPU 2 and the CPU 20, the processing of the CPU 2, and the processing of the CPU 20 are respectively shown, and the processing of the CPU 20 when other interrupt with higher priority is generated in the normal interrupt processing is shown below the processing of the CPU 20.

Note that the case where the CPU 2 and the CPU 20 alternately perform the interrupt processing is shown here.

In FIG. 7, the interrupt request signal is input from the interrupt control circuit 5 to the CPU 2. At this time, the interrupt data is output to the CPU 2 as described in the first embodiment. Then, the CPU 2 performs the interrupt processing including the interrupt response, the data read, the arithmetic processing, the result output and the interrupt return.

Subsequently, the interrupt request signal is output from the interrupt control circuit 5 to the CPU 20. Also in this case, similarly to the CPU 2, the interrupt data is output to the CPU 20. Then, the CPU 20 performs the interrupt processing including the interrupt response, the arithmetic processing, the result output and the interrupt return.

In the normal interrupt operation, the above-described interrupt processings of the CPU 2 and the CPU 20 are alternately repeated.

Next, the case where other interrupt with higher priority is generated in the normal interrupt processing of the CPU 20 as shown in the lower side of FIG. 7 will be described.

Here, it is assumed that, after the interrupt processing of the CPU 2 ends, the normal interrupt processing is generated immediately after the interrupt with higher priority is generated to the CPU 20.

In this case, the CPU 20 performs the interrupt processing of the high-priority interrupt and then performs the normal interrupt processing, but since the interrupt data is also input when the interrupt request signal is input to the CPU 20, the read processing of the interrupt data by the CPU 20 becomes unnecessary, and the interrupt data of the high-priority interrupt processing and the interrupt data of the normal interrupt processing generated immediately thereafter can be read before the next interrupt processing by the CPU 20.

FIG. 8 is a timing chart showing an example of the interrupt processing in the case where the semiconductor integrated circuit device 100 of FIG. 2 according to the first embodiment described above has a dual-core configuration.

From the top to the bottom of FIG. 8, the interrupt request signals input to the CPU 101 and the newly provided CPU, the processing of the CPU 101, and the processing of the newly provided CPU are respectively shown.

Also, in the semiconductor integrated circuit device 100 (FIG. 2), a CPU is newly provided to the configuration including the CPU 101, the ROM 102, the RAM 103, the interrupt control circuit 104, the peripheral modules 105 and 106, the bridge 107 and others. Furthermore, it is assumed that, in the interrupt processing, the CPU 101 and the newly provided CPU simultaneously perform the processing.

In FIG. 8, when the interrupt request signal is input from the interrupt control circuit 104 to the CPU 101 and the newly provided CPU, respectively, the CPU 101 and the newly provided CPU respectively perform the interrupt processing including the interrupt response, the data read, the arithmetic processing, the result output and the interrupt return.

This processing is to be performed each time when the interrupt request signal is output from the interrupt control circuit 104, but when the normal interrupt processing is generated to the CPU 101 immediately after the high-priority interrupt is generated as shown in FIG. 7, the CPU 101 performs the interrupt processing of the high-priority interrupt and then performs the normal interrupt processing.

However, compared with the interrupt processing of FIG. 7, two interrupt data reads in the high-priority interrupt via the low-speed bus 109 by the CPU 101 and the normal interrupt are required in the interrupt processing of FIG. 8. Therefore, the read of the normal interrupt data does not end before the next interrupt request signal, and the error of the interrupt processing occurs.

Also, FIG. 9 is a timing chart showing an example of the interrupt processing in the case where the semiconductor integrated circuit device 200 of FIG. 3 according to the first embodiment described above has a dual-core configuration.

From the top to the bottom of FIG. 9, similar to FIG. 8, the interrupt request signals input to the CPU 201 and the newly provided CPU, the processing of the CPU 201, and the processing of the newly provided CPU are respectively shown.

Also, in the semiconductor integrated circuit device 200 (FIG. 3), a CPU is newly provided to the configuration including the CPU 201, the ROM 202, the RAM 203, the interrupt control circuit 204, the peripheral modules 205 and 206, the bridge 207 and others. Furthermore, it is assumed that, in the interrupt processing, the CPU 201 and the newly provided CPU simultaneously perform the processing.

In FIG. 9, when the interrupt request signal is input from the interrupt control circuit 204 to the CPU 201 and the newly provided CPU, respectively, the CPU 201 and the newly provided CPU respectively perform the interrupt processing including the interrupt response, the data read, the arithmetic processing, the result output and the interrupt return.

In this case, since the interrupt data is also output to the interrupt control circuit 204 when the interrupt request signal is output from the arbitrary peripheral module, the read time of the interrupt data is shortened compared with the case of FIG. 8.

However, as described above with reference to FIG. 8, when the normal interrupt processing and the high-priority interrupt processing have to be performed, there arises a problem that the read of the interrupt data in the normal interrupt processing performed next to the high-priority interrupt processing does not end before the next interrupt request signal is generated, and the error of the interrupt processing occurs in some cases.

As described above, since the read processing of the interrupt data by the CPU 2 and the CPU 20 becomes unnecessary in the interrupt processing in the semiconductor integrated circuit device 1a, the interrupt processing can be performed with a sufficient margin even when other high-priority interrupt processing and others are generated.

Furthermore, by making the CPU 2 and the CPU 20 alternately perform the interrupt processing, the required clock speed can be reduced by about half (131 MHz/2=65.5 MHz), and the power consumption of the semiconductor integrated circuit device 1a can be reduced.

### Third Embodiment

The speeding up of the interrupt notification from the peripheral module 6 or the peripheral module 7 to the CPU 2 has been described in the first embodiment. In the third embodiment, the processing after the reception of the interrupt in the CPU 2 will be described.

In the first embodiment, in response to the interrupt request signal from the peripheral module 6 or the peripheral module 7, the priority determination unit 14 of the interrupt control circuit 5 determines the interrupt to be preferentially notified to the CPU 2 and notifies it to the CPU 2 via the dedicated wiring 17. The CPU 2 accesses the ROM 3 via the high-speed bus 9 based on the interrupt data stored in the register 2a.

At this point of time, when the other bus master circuit, for example, a DMA transfer control circuit (DMAC) connected to the high-speed bus 9 uses the high-speed bus 9, the determination of the bus use right based on the bus use priority of the CPU 2 and the bus master circuit is performed. When the bus use priority of the other bus master circuit is higher than that of the CPU 2, the access to the ROM 3 and others which is necessary when the CPU 2 performs the interrupt processing is blocked, and as a result, the execution of the interrupt processing is delayed.

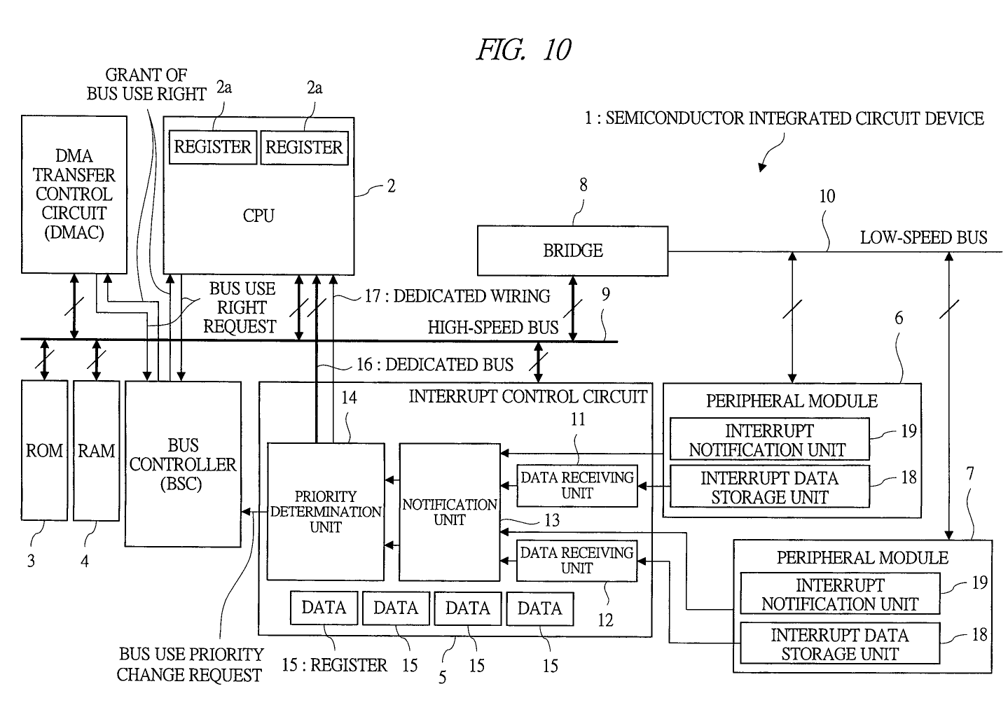

FIG. 10 is a block diagram showing an example of the semiconductor integrated circuit device according to the third embodiment. In FIG. 10, a DMA transfer control circuit DMAC which is an example of the other bus master circuit and a bus controller BSC which performs the bus use right determination of the high-speed bus 9 are added to the configuration in the block diagram shown in FIG. 1.

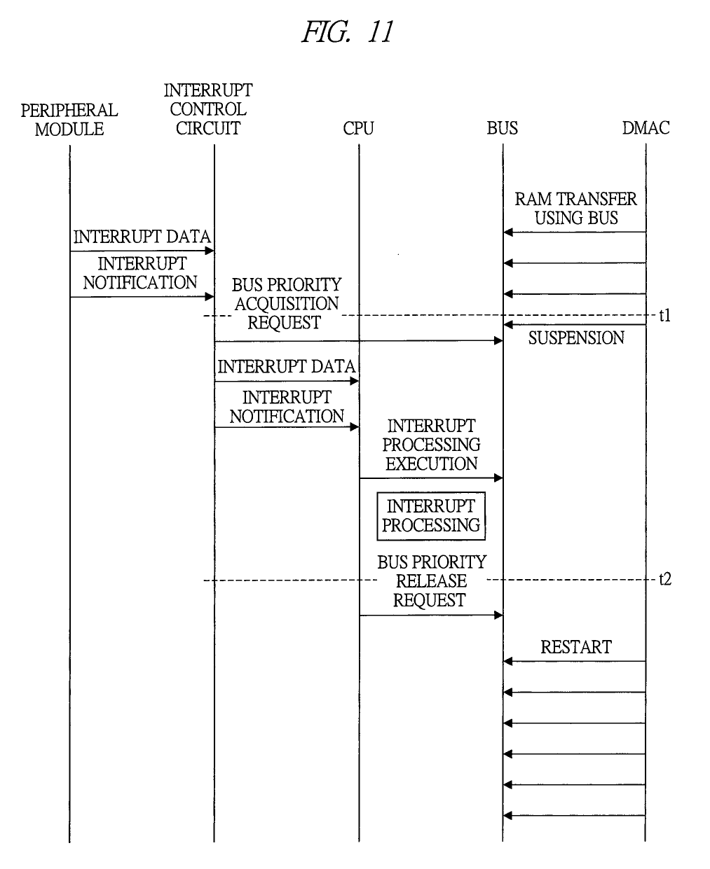

An example of the operation according to the third embodiment will be described with reference to FIG. 10 and FIG. 11 together.

The priority determination unit 14 of the interrupt control circuit 5 determines the interrupt request signals from the peripheral module, and when there is the interrupt request to be preferentially processed by the CPU 2, the priority determination unit 14 performs the interrupt notification to the CPU 2 and the storage of the interrupt data to the register 2a via the dedicated wiring 17 and the dedicated bus 16. At the same time, the priority determination unit 14 notifies the bus use priority change request to the bus controller BSC (timing t1).

In response to the bus use priority change request from the priority determination unit 14, the bus controller BSC changes the bus use priority of the high-speed bus 9 for the CPU 2 so as to be higher than that of the other bus master circuit.

Also, at the time point of the timing t1, since the issuance of the bus right grant request from the CPU 2 is expected, the bus controller BSC stops the grant of the bus use right for a predetermined amount of time with respect to the already-received bus right grant request of the high-speed bus 9 from the other bus master circuit to which the bus use right is not yet granted.

Furthermore, at the time point of the timing t1, for example when the DMA transfer control circuit DMAC is performing the data transfer by using the high-speed bus 9, the bus controller BSC notifies the suspension of the data transfer and the cancellation of the bus right grant to the DMA transfer control circuit DMAC, and the DMA transfer control circuit DMAC suspends the data transfer in response to the notification.

The CPU 2 issues the bus right grant request of the high-speed bus 9 to the bus controller BSC in order to read the address information at which the corresponding interrupt processing function is disposed from the ROM 3 based on the interrupt data. At the time when the CPU 2 issues the bus right grant request, the suspension of the data transfer in the DMA transfer control circuit DMAC can be completed or the suspension can be completed early, and therefore, the bus controller BSC can grant the bus use right to the CPU immediately or relatively early.

In response to the bus use right grant from the bus controller BSC, the CPU 2 accesses the ROM 3 via the high-speed bus 9 to fetch the location address information of the corresponding interrupt processing function and the corresponding interrupt processing function program. Also, with the interrupt processing function program, the CPU 2 accesses the RAM 4 via the high-speed bus 9 or accesses the peripheral modules 6 and 7 connected to the low-speed bus 10 via the bridge 8.

In response to the end of the execution of the corresponding interrupt processing function, the CPU 2 issues a bus priority release request to the bus controller BSC in order to release the bus use right and return the bus use priority (timing t2).

In response to the bus priority release request from the CPU 2, the bus controller BSC returns the bus use priority of the CPU 2 heightened at the timing t1 back to the original priority. Also, the bus controller BSC restarts the data transfer of the DMA transfer control circuit DMAC that was performing the data transfer by using the high-speed bus 9 at the timing t1, or the bus controller BSC grants the bus right to the bus master circuit which issues the highest-priority request among the bus right grant requests received at the time point of the timing t2.

By the configuration shown in the timing chart of FIG. 11, for the interrupt notification which needs to be preferentially processed, in the period between the reception of the interrupt notification in the CPU 2 and the execution start of the interrupt processing function, the occurrence of the delay of the execution start of the interrupt processing function in the CPU 2 due to that the other bus master circuit uses the high-speed bus 9 can be suppressed.

In particular, in the motor control illustrated in FIG. 4, the delay of the grant of the bus use right of the CPU 2 due to that the other bus master circuit uses the high-speed bus 9 and the occurrence of the variation in timing to output the control signal for controlling the motor can be reduced, and the motor control efficiency can be improved.

When a motor control circuit for controlling a motor is connected as a peripheral module, if only the bus use priority of the high-speed bus 9 of the CPU 2 is increased, the competition with the other bus master circuit is likely to occur in the bus use of the low-speed bus 10 via the bridge 8, and therefore, it is preferable to perform the similar control to the high-speed bus 10 also for the low-speed bus 10.

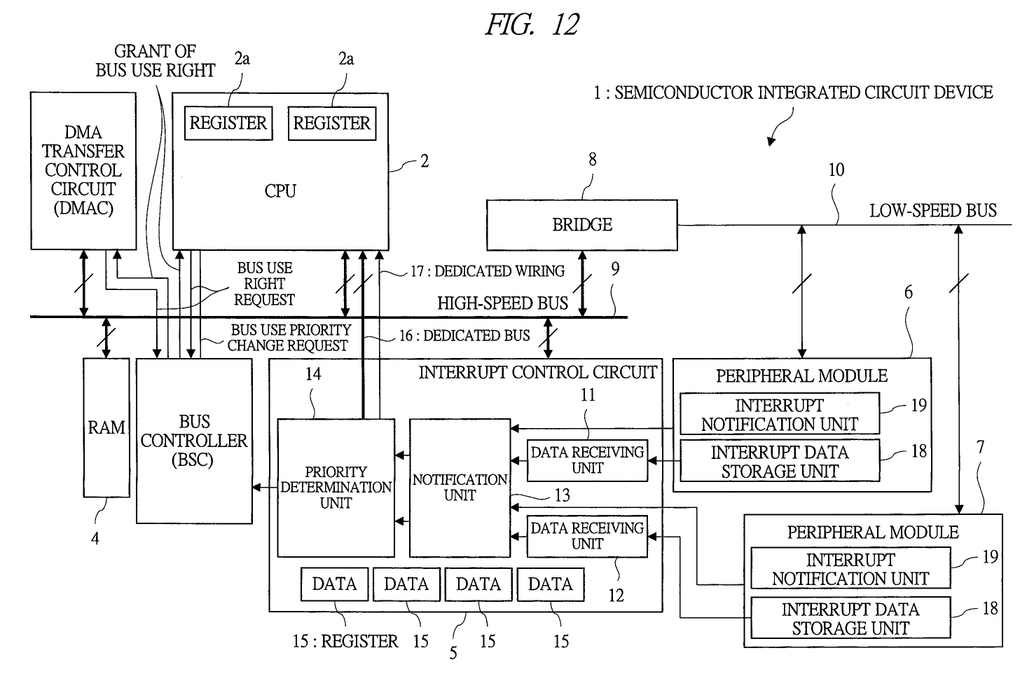

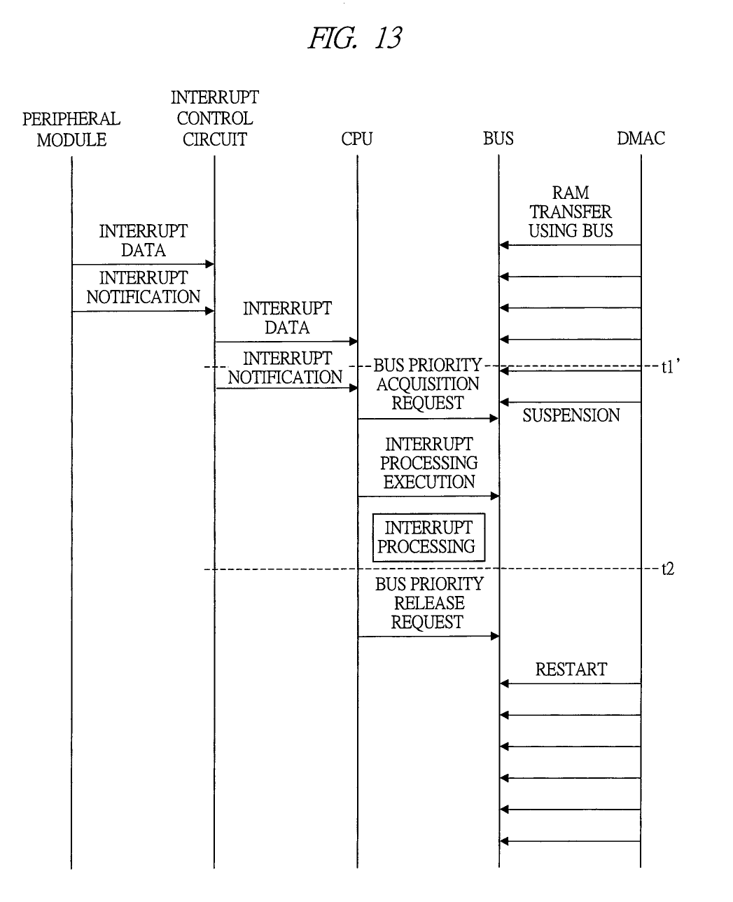

Next, in the case of the semiconductor integrated circuit device with the configuration shown in FIG. 12, it is not necessary to use the high-speed bus 9 for fetching the address information of the interrupt processing function and the program. Another example of the operation according to the third embodiment in the case of the semiconductor integrated circuit device with the configuration like this will be described with reference to FIG. 12 and the timing chart of FIG. 13 together.

The difference from the operation shown in the timing chart of FIG. 11 is that the bus priority acquisition request that is issued by the priority determination unit 14 in FIG. 11 is issued by the CPU 2 in the operation shown in the timing chart of FIG. 13.

When the interrupt request to be preferentially processed by the CPU 2 exists, the priority determination unit 14 of the interrupt control circuit 5 performs the interrupt notification to the CPU 2 and the storage of the interrupt data to the register 2a via the dedicated wiring 17 and the dedicated bus 16.

In response to the interrupt notification, the CPU 2 determines whether it is necessary to preferentially use the high-speed bus 9 based on the interrupt data. When it is determined that it is necessary to preferentially use the high-speed bus 9, the CPU 2 issues the bus use priority change request to the bus controller BSC (timing t1′).

The processing of the bus controller BSC which has received the bus use priority change request and the operation of the CPU 2 after the bus use right is granted except the ROM access may be the same as those of the description with reference to FIG. 11.

In the case of the semiconductor integrated circuit device of FIG. 12, the competition in the bus use right acquisition of the high-speed bus 9 does not occur in the acquisition of the address information of the interrupt processing function and the fetching of the program between the CPU 2 and the other bus master circuit.

However, when a motor control circuit is connected as the peripheral module, since the CPU 2 needs to transfer the control information for controlling the motor to the motor control circuit as the peripheral module via the high-speed bus 9 and the low-speed bus 10, the competition in the bus use right acquisition in the transfer like this can be prevented.

In the case of the multi-core configuration as shown in FIG. 6, the CPU that receives the interrupt notification from the interrupt control circuit corresponds to the CPU 2 of FIG. 10 and the other CPU corresponds to the other bus master circuit.

Note that, as the techniques described in the third embodiment, regarding to the bus arbitration for changing the bus use priority temporarily, Japanese Patent Application Laid-Open Publication No. 2008-130056, Japanese Patent Application Laid-Open Publication No. 2008-191987 and others are known.

In the foregoing, the invention made by the inventor of the present invention has been concretely described based on the embodiments. However, it is needless to say that the present invention is not limited to the foregoing embodiments and various modifications and alterations can be made within the scope of the present invention.

The present invention is suitable for the technique for reducing the load factor of the CPU in the interrupt processing.

What is claimed is:

1. A semiconductor integrated circuit device comprising:
a CPU;
an interrupt control circuit for controlling an interrupt processing to the CPU;
a first bus to which the CPU and the interrupt control circuit are connected;
at least one peripheral module which is accessible from the CPU; and
a second bus to which the peripheral module is connected and which has a data transfer rate lower than that of the first bus,
wherein, when an interrupt from the peripheral module is generated, the interrupt control circuit outputs an interrupt request signal to the CPU to notify the interrupt generation and also performs a processing to transfer interrupt data of the peripheral module.

2. The semiconductor integrated circuit device according to claim 1,
wherein the interrupt control circuit includes:
a storage unit which stores the interrupt data output from the peripheral module when the interrupt request signal is output from the peripheral module; and
a priority determination unit which determines an interrupt priority based on the interrupt request signal output from the peripheral module from which the interrupt is generated and outputs its determination result and the interrupt data stored in the storage unit to the CPU.

3. The semiconductor integrated circuit device according to claim 2,
wherein the priority determination unit and the CPU are connected by a dedicated bus, and the interrupt data of the peripheral module is transferred via the dedicated bus.

4. The semiconductor integrated circuit device according to claim 3,
wherein the peripheral module and the interrupt control circuit are connected by a serial bus, and the interrupt data is transferred from the peripheral module by serial communication.

5. A semiconductor integrated circuit device comprising:
two or more CPUs;
an interrupt control circuit for controlling an interrupt processing to the two or more CPUs;
a first bus to which the two or mores CPUs and the interrupt control circuit are connected;
at least one peripheral module which is accessible from the two or more CPUs; and
a second bus to which the peripheral module is connected and which has a data transfer rate lower than that of the first bus,
wherein, when an interrupt from the peripheral module is generated, the interrupt control circuit outputs an interrupt request signal to the CPU to notify the interrupt generation and also performs a processing to transfer interrupt data of the peripheral module.

6. The semiconductor integrated circuit device according to claim 5,
wherein the interrupt control circuit includes:
a storage unit which stores the interrupt data output from the peripheral module when the interrupt request signal is output from the peripheral module;
a priority determination unit which determines an interrupt priority based on the interrupt request signal output from the peripheral module from which the interrupt is generated; and
an interrupt notification determination unit which determines which CPU of the two or more CPUs the interrupt is notified to and outputs a determination result of the priority determination unit and the interrupt data stored in the storage unit to the determined CPU.

7. The semiconductor integrated circuit device according to claim 6,
wherein the interrupt notification determination unit and the CPU are connected by a dedicated bus, and the interrupt data of the peripheral module is transferred via the dedicated bus.

8. The semiconductor integrated circuit device according to claim 7,
wherein the peripheral module and the interrupt control circuit are connected by a serial bus, and the interrupt data is transferred from the peripheral module by serial communication.
